(19) United States
(12) Patent Application Publication
(10) Pub. No.: US 2007/0160081 A1
(43) Pub. Date: Jul. 12, 2007

(54) Integrated power line communications interface for performing communications protocol processing on a plurality of classes of communications data

(76) Inventors: Oleg Logvinov, East Brunswick, NJ (US); Michael J. Macaluso, Highland Park, NJ (US)

Correspondence Address: Mr. James Reeber;Arkados, Inc., 948 U.S. Highway #22 East, North Plainfield, NJ, 07060, US

(21) Appl. No.: 11/009,628

(22) Filed: Dec. 10, 2004

Related U.S. Application Data
(60) Provisional application No. 60/528,663, filed on Dec. 10, 2003.

(51) Int. Cl. H04J 3/16; H04J 1/16

(52) U.S. Cl. 370/469; 370/235

(57) ABSTRACT

An integrated power line communications (“PLC”) interface is coupled to a power line communications network and can simultaneously process a plurality of classes of communications data for automatically and dynamically establishing class-specific communications interfaces with communications network appliances or communications device coupled to the PLC network.

### CROSS REFERENCE TO RELATED APPLICATION

This application claims the benefit of U.S. Provisional Application Ser. No. 60/528,663, filed Dec. 10, 2003, assigned to the assignee of this application and incorporated by reference herein.

### FIELD OF THE INVENTION

The present invention relates generally to communications data transmission over a power line communications (“PLC”) network and, more particularly, to an integrated power line communications interface that is coupled to a PLC network and can perform communications protocol processing on a plurality of classes of communications data.

### BACKGROUND OF THE INVENTION

Communications signal transmissions occurring over a home communications network generally are categorized as constituting either control networking or data networking. Control networking generally involves a class of data communications considered to have low bandwidth requirements, i.e., a low speed class of communications. In contrast, data networking generally involves classes of data communications considered to have much higher bandwidth requirements than control networking. These higher bandwidth communications are conventionally called medium speed and high speed classes of data communications.

In control networking, low speed data communications is generally used to transmit simple control and feedback data to communications network devices, where the network devices can have varying degrees of intelligence. A low speed communications network device can include, for example, such low intelligence devices as a light switch, a motion sensor or other typical home automation device. Control networking also can be used with network communications devices having relatively high levels of intelligence, such as found in integrated home electronics including televisions, DVD players, etc.

The cost of a network communications device, and thus a communications network including a plurality of the network devices for which control networking is required, is driven, to some extent, by the class (speed) of communications data that must be used for controlling operation of the network device. Therefore, network control nodes typically will be integrated into network devices requiring lower speeds for operation. These lower speed devices, for example, can have a required bit rate for control networking that typically is less than 500 Kbps.

In data networking, different types of data traffic, operating at either medium or high speeds, are likely to exist on the communications network at the same time. As is well known in the art, Quality of Service (“QoS”) becomes an important consideration when relatively higher speed (bandwidth) data communications are involved. Medium speed data networking devices conventionally require data communications to occur at speeds of up to 10 Mbps. Medium speed data traffic can include, for example, one or multiple VoIP calls, web browsing, file sharing, audio distribution, etc. In addition, communications between network appliance types of devices usually involve medium speed data traffic. It is expected that a PLC network will include many network devices in the medium speed class that will access WAN or internet resources simultaneously. Therefore, the speed of the PLC network needs to be higher than that of a typical broadband internet connection, which usually varies from several hundred Kbps to several Mbps. Medium speed networking can be thought of as a 10 Mbps class network.

High speed devices are those devices whose bandwidth requirements are much greater than those of medium speed networks. High speed data traffic involved in data networking can include, for example, high speed AV (audio/video) data distribution, such as SDTV and HTDV signals, and conventionally require speeds of up to 100 Mbps. Also it is well known in the art that QoS management is especially important for such high speed data traffic. For example, most high speed audio/video devices transmit high bit rate isochronous traffic, such as 24 Mbps for a single HDTV stream.

The differences between the data communications bandwidth requirements for control and data networking, and the disparity in costs of hardware and software equipment necessary for implementing the respective networking in accordance with associated bandwidth requirements, makes it unlikely that the same physical communications protocol layer technology would be used to implement both a control network and a data network application in a single network device. In addition, it is unlikely that the same physical layer communication parameters and data transmission framing would be used for both control and data networking communication, thereby resulting in the problem that control and data devices cannot exchange information directly with each other. For example, in an application of a PC with a data connection and where the PC executes a home automation software package for controlling network devices coupled to a PLC network, it would be undesirable and unnecessarily costly to have the PC include two interfaces for connecting to the same power line medium.

Therefore, there exists a need for a communications apparatus for interfacing with different classes of communications data so as to bridge control and data networking on a PLC communications network.

### SUMMARY OF THE INVENTION

In accordance with the present invention, an integrated power line communications (“PLC”) interface is coupled to a conventional electrical power media of a PLC network for receiving and transmitting communications signals at the coupled location, and can perform communications protocol processing on a plurality of bandwidth (speed) classes of communications data, preferably simultaneously, to facilitate exchange of classes of communications data associated with data and control networking with a plurality of communications devices or communications network appliances also coupled to the conventional electrical power media of the PLC network.

In a preferred embodiment, the PLC interface includes an analog front end (“AFE”) for coupling to the power line communications medium. The AFE can perform communications signal transmission and reception operations for a plurality of classes of communications data corresponding to data and control networking. The AFE is preferably reconfigurable or selectively operable to perform processing corresponding to at least two classes of communications data. The PLC interface further includes a physical communications protocol layer (“PHY”) module, a media access controller communications protocol layer (“MAC”) module and a stack communications protocol layer module. Each of the PHY, MAC and stack layer modules is operable, selectively or based on software programming, for processing communications data in at least two classes. The combination of the PHY, MAC and stack layer modules couples the AFE to an interface communications protocol layer module in the PLC interface. The interface module constitutes a communications protocol layer that is above the stack layer module in a communications protocol hierarchy, and performs standard bridging, routing and translation operations conventional in most networking devices. The interface module performs end data processing for data destined for a communications device directly interfaced with the PLC interface. In addition, the interface module performs data processing to prepare data, which is destined for a communications device or network appliance on a network other than the PLC network, for forwarding to communications network devices or communications network processing modules which may be contained within or outside the PLC interface and which may be used for establishing communications connectivity and forwarding data between the PLC interface and the destination communications device or network appliance.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a block diagram of an integrated power line communications interface in accordance with the present invention.

FIG. 2 is a block diagram of another embodiment of a power line communications interface in accordance with the present invention.

FIG. 3 is a block diagram of still another embodiment of a power line communications interface in accordance with the present invention.

### DETAILED DESCRIPTION OF THE INVENTION

The inventive integrated power line communications (“PLC”) interface combines communications protocol operations associated with the physical communications protocol layer (“PHY”), the media access control communications protocol layer (“MAC”) and the stack communications protocol layer for performing control and data networking using the same analog front end (“AFE”). By utilizing a single AFE module which is connected to a PLC network (not shown) and capable of transmitting onto, and receiving from, the network both control and data signals, significant overall system cost savings can be achieved. As dedicated AFE circuitry for each class of communications data likely has similar functionalities, a data class AFE as conventionally known in the art, with no or only minor modifications, also can be utilized for control class communications. Such sharing of the AFE circuitry to perform data and control networking operations corresponding to different classes of communications data can achieve equipment savings to the point that a control network interface can be added to a data network interface on a same PLC interface apparatus at negligible additional cost.

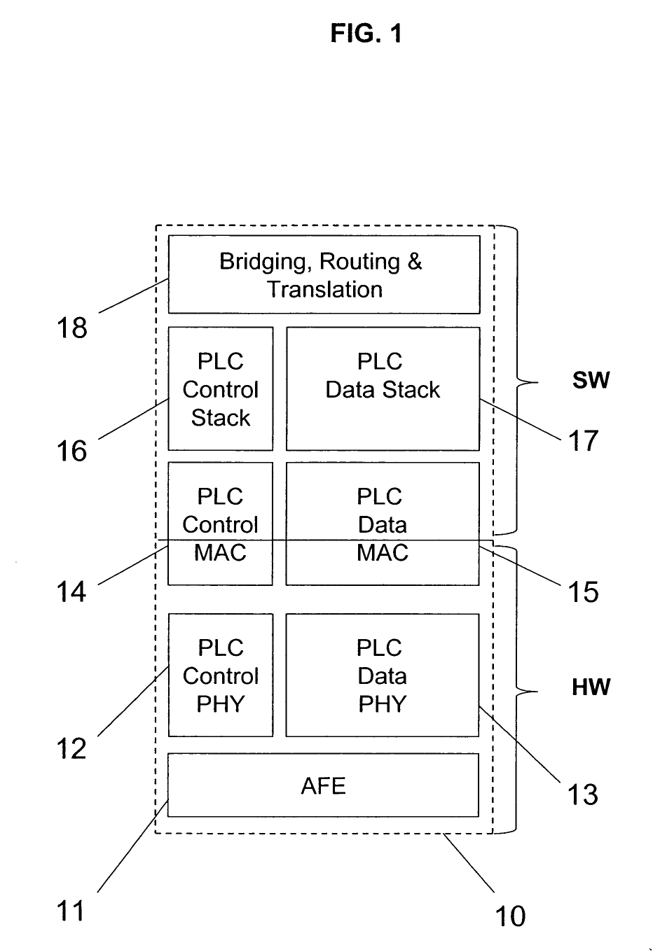

FIG. 1 shows an exemplary PLC interface 10 in accordance with the present invention. The PLC interface 10 includes an analog front end (“AFE”) module 11 for coupling to a power line communications medium. The AFE 11 can perform communications signal transmission and reception operations for multiple classes of communications data, where the communications signals, for example, correspond to signals for control class and data class devices or appliances. The AFE 11 may be constructed to be re-configurable or selectively operable to perform processing corresponding to either control class or data class communications signals. In a preferred embodiment, based on well known in the art signaling requirements, the AFE 11 includes circuitry for a standard data class PLC communication device, with optional minor modifications for operating in accordance with the signaling requirements of control class communication protocols.

The PLC interface 10 further includes physical communications protocol layer (“PHY”) modules 12 and 13, media access controller communications protocol layer (“MAC”) modules 14 and 15 and stack communications protocol layer modules 16 and 17 for control class and data class communications functionalities, respectively. In a preferred embodiment of the PLC interface, each of the PHY, MAC and stack layer modules is operable, either selectively or based on software programming, for processing communications data for a specific class of communications data.

The combination of the PHY, MAC and stack layer modules couples the AFE to an interface communications protocol layer, shown as a bridging, routing, and translation module 18 in the PLC interface 10. The bridging, routing, and translation module 18 constitutes a communications protocol layer that is above the stack layer module in a communications protocol hierarchy and performs standard bridging, routing, and translation operations conventionally occurring in most networking devices. In a preferred embodiment, the interface module 18 performs end data processing for data destined for a communications device directly interfaced with the PLC interface. In a further preferred embodiment, the interface module 18 performs data processing to prepare data, which is destined for a communications device or network appliance on a network other than the PLC network, for forwarding to communications network devices or communications network processing modules which may be contained within or outside the PLC interface and which may be used for establishing communications connectivity and forwarding data between the PLC interface and the destination communications device or network appliance.

FIG. 1 also shows a preferred implementation of the various module blocks of the PLC interface 10 in terms of hardware and software. Referring to FIG. 1, the AFE module 11, the PHY modules 12 and 13 and the physical interface portion of the MAC modules 14 and 15 are implemented in hardware, and the MAC parameters and the remaining functionalities of the MAC modules 14 and 15, the stack modules 16 and 17 and the bridging, routing and translation module 18 are implemented in software. Although the preferred embodiment of the PLC interface 10 illustrated in FIG. 1 shows the demarcation point of hardware and software in the MAC modules, it is to be understood that various hardware and software implementations of the PHY, MAC and stack layer modules can be used in accordance with the present invention.

In a preferred embodiment, the PLC interface 10 is implemented using system on a chip (“SoC”) architecture technology to provide for an integrated processor that performs both low level MAC operation and also executes application code. The SoC architecture implementation advantageously provides an excellent platform for building an integrated data/control bridge device.

Since the AFE is shared, the increased system level cost to integrate both data and control networking capabilities simultaneously is practically nonexistent. As low speed PHY and MAC silicon sizes are negligible when compared to the data networking components and system level components for an SoC implementation, the implementation of data and control networking bridging in the same SoC implementation can be achieved at little extra cost.

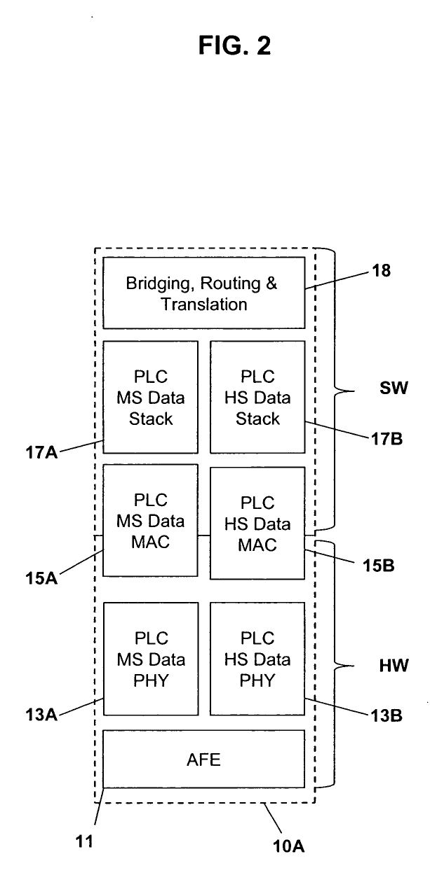

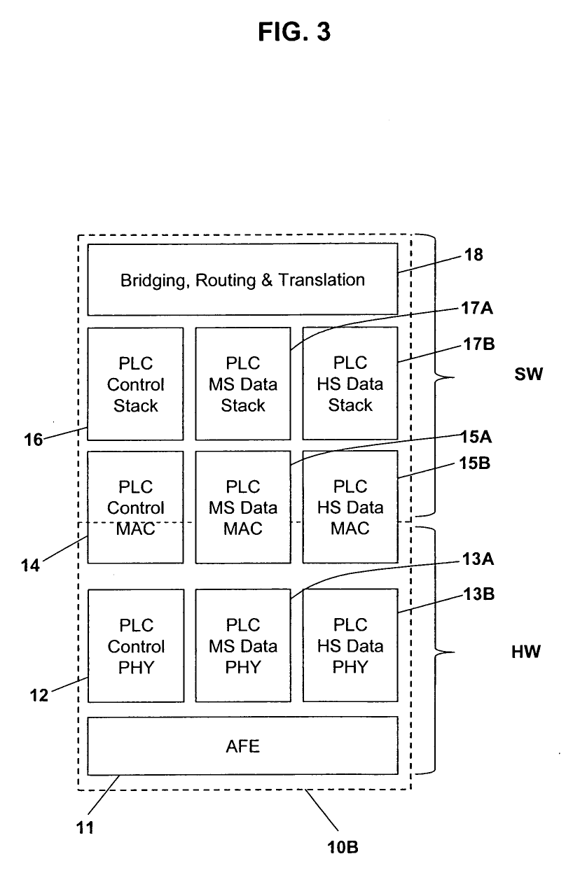

In addition to combining data and control networking, medium speed data networking and high speed data networking similarly can be combined in the same PLC interface implemented using SoC technology. Referring to FIGS. 2 and 3 which illustrate alternative preferred embodiments of PLC interfaces 10A and 10B respectively, the same PLC interface in accordance with the present invention can include both medium and high speed data interface capabilities, or a combination of medium data, high speed data and low speed (control networking) capabilities. The advantages of the implementation of the PLC interface 10 similarly apply to the PLC interfaces 10A, 10B, in that the existence of only a singular implementation of the AFE functionality, as well as the bridging, routing, and translation functionalities, in a PLC interface provides significant densities of scale advantages, such as cost, size and power reductions. Thus, the inventive PLC interface, with only a singular implementation of the AFE functionality and the bridging, routing, and translation functionalities, can be configured or programmed, as desired, to provide for communications using multiple and different classes of devices.

In addition, the inventive multi-class PLC interface provides others advantages. It is known that to overcome operational difficulties associated with utilizing a single physical PLC medium for multiple classes of communication, and in some cases even having two or more different logical networks present on the same medium, intelligent algorithms and methods, as well as intelligent interfaces, usually need to be employed. The use of the inventive multi-class communication PLC interface, as described above, avoids the need for use of such intelligent algorithms, methods and interfaces, while providing for multiple class communication operations, and also preserving the PLC communication medium integrity and maximizing bandwidth availability.

By utilizing separate processing blocks for different classes of communications in a multi-class PLC communication interface as described above in accordance with the present invention, different class communication events can be handled simultaneously. For example, in a preferred embodiment the AFE, PHY, and MAC modules in a PLC interface can operate to handle low speed data communication events while simultaneously processing medium and high speed communication data. In a further preferred embodiment, the same implementation of AFE, PHY, and MAC in a PLC interface operates to handle low, medium and high speed data types or, alternatively, a plurality of classes in a time division multiplexed fashion. In still a further preferred embodiment, the PLC interface can perform data handling of multiple classes where frequency division multiplexing is used to separate data class types, or to allow for bandwidth reuse.

In an alternative preferred embodiment, the PLC interface performs data handling of multiple communications classes on a single physical medium and utilizes a universal signal structure to generate the communications signals to be transmitted to devices having control and data networking communications functionalities that are coupled to the PLC network. The universal signal structure provides that the transmitted communications signals can be interpreted by devices operating in accordance with any of a plurality of class types. For example, the universal signal structure provides that individual devices coupled to the PLC network that are designed to receive low speed data, medium speed data or high speed data can interpret any communication events taking place on the PLC network medium. Consequently, the amount of intelligence required for all classes of devices on a PLC network can be maintained at a minimum, because each device only has to detect and decode a single type of signal structure. Further, the same or very similar interface circuitry at the PLC interface can be utilized for all data communication class devices, thereby reducing the size of the PLC interface and the cost of having multi-class capabilities in a single interface or having dedicated medium and high speed class devices or appliances.

In a further preferred embodiment, the inventive PLC interface can be constructed to contain a re-configurable AFE that provides adaptive filtering and power output control to support a specific type or class (low-speed, high-speed, or medium-speed) of data transmission and reception over the power line medium. Also, the PLC interface can include a dynamic PHY and AFE interface configuration that maximizes the throughput performance for a specific traffic type, for example, utilizing ideal packet lengths for specific applications, such as VoIP.

In still a further preferred embodiment, the inventive PLC interface includes additional intelligence to maximize other PLC medium performance features by providing native protocol encapsulation translation of a traffic type into protocol encapsulation based on the selected destination and traffic type of the network path. For example, the interface module of the PLC interface can operate to translate communications data encoded in accordance with a first data communication class into communications data encoded for transmission to a selected network address and based on the class of communications data available for use in transmission on a network path extending to the selected network address.

In a further preferred embodiment, the PLC interface performs protocol translation based on dynamic network path selection that attempts to account for non-homogeneities in a power line communication network. For example, the interface module of the PLC interface translates a first data communications class into a second data communications class based on information representative of transmission characteristics of network paths of a power line communication network to which the PLC interface is coupled. Such capability provides for improved overall communication performance by minimizing retransmissions and multi-hop transmissions in cases of multi-network PLC mediums.

In a preferred embodiment, any of the above-described embodiments of the inventive PLC interface are implemented in a SoC architecture to provide cost-effectiveness and an easily re-configurable and adaptive solution for multi-class PLC communication network devices and appliances.

Although preferred embodiments of the present invention have been described and illustrated, it will be apparent to those skilled in the art that various modifications may be made without departing from the principles of the invention.

What is claimed is:

1. An integrated power line communications (“PLC”) interface comprising:
an analog front end (“AFE”) for coupling to a power line communications medium of PLC network and for performing communications signal transmission and reception operations for a plurality of classes of communications data;
a physical communications protocol layer (“PHY”) module coupled to the AFE and a media access controller communications protocol layer (“MAC”) module, wherein the MAC module is further coupled to a stack communications protocol layer module, wherein each of the PHY, MAC and stack layer modules is operable for processing communications data in at least two of the plurality of classes; and
an interface communications protocol layer module for interfacing the stack layer module with a communications protocol layer that is above the stack layer module in a communications protocol hierarchy.

2. The PLC interface of claim 1, wherein the classes include at least low, medium and high speed data communications traffic and the interface module performs data routing, network bridging and network translation operations.

3. The PLC interface of claim 1, wherein the interface module performs data processing operations for communicatively interconnecting the PLC interface with a communications device or a communications network on a network other than the PLC network.

4. The PLC interface of claim 1, wherein each of the PHY, MAC and stack modules includes a designated low speed data communications traffic module and a data communications traffic module selectable for processing medium or high speed data communications traffic.

5. The PLC interface of claim 2, wherein the AFE is for performing communications signal transmission and reception operations on time division multiplexed communications signals and each of the PHY, MAC and stack modules is operable for processing communications data carried on time division multiplexed communications signals.

6. The PLC interface of claim 2, wherein the AFE is for performing communications signal transmission and reception operations on frequency division multiplexed communications signals and each of the PHY, MAC and stack modules is operable for processing communications data carried on frequency division multiplexed communications signals.

7. The PLC interface of claim 2, wherein the AFE performs communications signal transmission operations, and each of the PHY, MAC and stack modules performs processing on communications data, for generating a communications data signal encoded in accordance with a universal signal structure, wherein the universal signal structure includes data blocks corresponding to each of the plurality of classes of communications data, such that communications devices coupled to the PLC network and operating using at least one of the plurality of classes can interpret data communications transmissions from the PLC interface.

8. The PLC interface of claim 1, wherein the AFE is selectively operable to perform adaptive filtering and control output power of communications signals including at least two classes of communications data selected from the plurality of classes of communications data.

9. The PLC interface of claim 1, wherein the AFE identifies the communications data class of a first communications data packet to be transmitted onto or received from the power line medium and automatically performs communications signal transmission and reception operations corresponding to the identified class, and wherein each of the PHY, MAC and stack modules automatically performs processing operations on the first communications data packet corresponding to the identified class.

10. The PLC interface of claim 1, wherein the interface module translates communications data encoded in accordance with a first data communication class into communications data encoded for transmission to a selected network address and based on the class of communications data available for use in transmission on a network path extending to the selected network address.

11. The PLC interface of claim 1, wherein the interface module translates a first data communications class into a second data communications class based on information representative of transmission characteristics of network paths of a power line communication network to which the PLC interface is coupled.

12. The PLC interface of claim 1, wherein the AFE performs communications signal transmission and reception operations simultaneously on at least two of the plurality of classes of communications data; and
wherein each of the PHY, MAC and stack layer modules simultaneously processes communications data for the least two of the plurality of classes.

13. The PLC interface of claim 1, wherein at least one of or a portion of the AFE module, the PHY, MAC and stack modules and the interface module is implemented using a system on chip architecture.
